(19) United States
(12) Patent Application Publication
(10) Pub. No.: US 2025/0318505 A1
(43) Pub. Date: Oct. 16, 2025

(54) Animal Training Collar Device

(71) Applicant: Brian Heuer, Windsor, CO (US)

(72) Inventor: Brian Heuer, Windsor, CO (US)

(21) Appl. No.: 19/095,129

(22) Filed: Mar. 31, 2025

Related U.S. Application Data
(60) Provisional application No. 63/632,189, filed on Apr. 10, 2024.

(51) Int. Cl. A01K 15/02; A01K 11/00; A01K 27/00

(52) U.S. Cl. CPC A01K 15/021; A01K 11/008; A01K 27/006; A01K 27/009

(57) ABSTRACT

An animal training collar device is disclosed, which is a training collar for multiple animals. The animal training collar device comprises a body component that is configured in a conventional round-shaped animal collar. The body component secures around a user's neck and comprises a built-in receiver/speaker system for delivering vocal commands. The device allows for voice, beep, vibration, and shock control options. The device includes features, such as volume control, a built-in speaker, waterproof materials, a carrying case, adjustable vibration, and shock levels. Further, the device includes a one-mile range with GPS tracking via a mobile app. Additionally, the device has the ability to control up to two collars with one remote and includes rechargeable batteries.

### CROSS-REFERENCE TO RELATED APPLICATION

The present application claims priority to, and the benefit of, U.S. Provisional Application No. 63/632,189, which was filed on Apr. 10, 2024, and is incorporated herein by reference in its entirety.

### FIELD OF THE INVENTION

The present invention relates generally to the field of animal training collar devices. More specifically, the present invention relates to an animal training collar that allows a user to train an animal via vocal commands produced by the collar. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in animal training collar devices. Generally, existing animal training collars often rely on vibrations, shocks, or beeps to correct or instruct an animal. However, hearing the trainer's voice can often be enough to correct animal behavior. Additionally, dog handlers know that field conditions and other distractions, such as distance, wind, heavy cover, other dogs, and other handlers' whistles or voice commands, can often hinder a trainer's ability to communicate with their dog. The animal training collar device of the present invention lets owners give direct vocal commands to their dogs, helping to focus their attention and allowing them to hear their owner's voice loud and clear regardless of distance or environmental conditions. Thus, the device is intended to offer owners a more humane and effective option for training their dogs.

Accordingly, there is a demand for an improved animal training collar device that allows users to send voice commands directly to the collar. More particularly, there is a demand for an animal training collar device that has a built-in receiver/speaker designed for giving vocal commands to animals that have ranged outside of normal voice and whistle range.

Therefore, there exists a long felt need in the art for an animal training collar device that allows a user to train an animal via vocal commands produced by the collar. There is also a long felt need in the art for an animal training collar device that comprises a built-in receiver/speaker system for delivering vocal commands. Further, there is a long felt need in the art for an animal training collar device that allows for voice, beep, vibration, and shock control options. Moreover, there is a long felt need in the art for a device that includes volume control, a built-in speaker, waterproof materials, and a carrying case. Further, there is a long felt need in the art for an animal training collar device that has one mile range with GPS tracking via a mobile app. Finally, there is a long felt need in the art for an animal training collar device that has the ability to control up to two collars within one remote.

The subject matter disclosed and claimed herein, in one embodiment thereof, comprises an animal training collar device. The device is a training collar for multiple animals. The animal training collar device comprises a body component that is configured in a conventional round-shaped animal collar. The body component secures around a user's neck and comprises a built-in receiver/speaker system for delivering vocal commands. The device allows for voice, beep, vibration, and shock control options. The device includes features, such as volume control, a built-in speaker, waterproof materials, a carrying case, adjustable vibration, and shock levels. Further, the device includes a one-mile range with GPS tracking via a mobile app. Additionally, the device has the ability to control up to two collars with one remote and includes rechargeable batteries.

In this manner, the animal training collar device of the present invention accomplishes all of the forgoing objectives and provides users with a device that allows a user to train an animal via vocal commands. The device is a collar with built-in receiver/speaker system for delivering vocal commands. The device allows a user to control up to two collars with one remote.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal training collar device. The device is a training collar for multiple animals. The animal training collar device comprises a body component that is configured in a conventional round-shaped animal collar. The body component secures around an animal's neck and comprises a built-in receiver/speaker system for delivering vocal commands. Additionally, the device has the ability to control up to two collars with one remote and includes rechargeable batteries.

In one embodiment, the animal training collar device of the present invention comprises all the features found in traditional training collars, plus the additional advantage of having a built-in receiver/speaker designed for giving vocal commands to hunting dogs, herding dogs, and field trial dogs that have ranged outside of normal voice and whistle range, etc., or any other suitable animal that primarily utilizes vocal commands for training.

Other electronic training collars use beeps, vibrations, and electric shock to correct dogs, but hearing the trainer's voice can often be enough to correct behavior. Additionally, dog handlers know that field conditions and other distractions, such as distance, wind, heavy cover, other dogs, and other handlers' whistles or voice commands can often hinder a trainer's ability to communicate with their dog. Accordingly, the animal training collar device of the present invention lets owners give direct vocal commands to their dogs, helping to focus their attention, and allowing them to hear their owner's voice loud and clear regardless of distance or environmental conditions.

In one embodiment, the animal training collar device comprises a body component that is configured in a round-shape for wrapping around the neck of a dog or other suitable animal. The body component comprises a nylon or polyester material and has an appearance similar to a conventional dog collar for comfortable wearing of the body component. The elongated shape of the body component is adapted to encircle the neck of a dog in a similar fashion as conventional dog collars known in the art. The body component can be made of a slash-proof and soft material such as nylon webbing, polyester, hemp, or metal, etc., or any other suitable material as is known in the art.

In use, the body component is secured around the neck of a dog via a buckle and a clip, which mate together and are integrated into the body component. Further, the buckle may comprise a key-locking mechanism that locks the clip into the buckle when engaged. Additionally, any other type of fastening mechanism such as hook and loop, Velcro®, buckle, snap, etc., or any other mechanical fastener as is known in the art can be used for securing the ends of the body component.

In one embodiment, the body component includes a waterproof housing attached to the body component or directly integrated within the body component, which includes a built-in receiver/speaker, a long-range antenna, and other circuitry necessary for delivering vocal commands, as well as for beep, vibration, and shock control options. Further, the built-in receiver/speaker includes a low-profile volume control with physical clicks to prevent accidental changes and a low-profile power button to activate or deactivate the built-in receiver/speaker. Specifically, the power button can be used for activation when the dog is wearing the body component and being trained. For power saving properties, the power button can be deactivated manually or after a predetermined amount of time when the body component is not worn by the dog, the built-in receiver/speaker will automatically shut off. Further, the built-in receiver/speaker comprises interchangeable electrodes, which can be interchanged as necessary, allowing the device to be utilized with long-haired and short-haired dogs and other animals.

In one embodiment, the device includes a remote control/control module with an attached lanyard for easy transport and a waterproof housing for protection against the elements. The remote control/control module includes a transmitter, an antenna, and other circuitry needed for sending vocal commands to the body component/collar. Further, the remote control/control module includes a microphone and a push-to-talk button, which allows a user to speak their commands into the remote control. The control module also comprises a recessed channel switch, which allows a user to switch between channels, as needed to avoid any interference while using the device. Additionally, the control module includes low-profile buttons within a recessed face. The low-profile buttons include a first button for sounding a beep, a second button for sending a vibration, and a third button that sends a shock. The third button is a smaller button with a dial to control the concentration of the shock being sent. If a user wants to send a continuous shock, the third button can be held down. The low-profile buttons allow for adjustable vibration and shock stimulation levels, as needed.

In one embodiment, the animal training collar device has the ability to control up to two body components/collars with one remote control/control module.

In one embodiment, the housing comprises a GPS tracker which allows users to track the location of their pet. Typically, the device has a one-mile range for transmitting and receiving voice commands. Specifically, the housing has a built-in GPS chip that determines the location of the body component and provides the location information to the dog owner using a wireless communication module connected to a paired smart device. Specifically, the wireless communication module establishes a wireless communication channel with the paired smart device. Further, the animal training collar device connects to the smart device, such as smartphone, personal digital assistant, or any other such type of electronic/mobile device using the wireless communication medium such as Bluetooth, Wi-Fi or any other similar short range or long-range wireless technology as is known in the art. Specifically, the smartphone device comprises an installed mobile application that receives information related to the location of the animal, etc., in real time. The alert or notification shown on the mobile application may be in the form of a push notification, audio alert or a visual alert, etc., or any other suitable notification as is known in the art.

In one embodiment, the animal training collar device of the present invention comprises an internal battery, which runs for up to forty hours or more. Typically, the animal training collar device may support built-in high-capacity lithium rechargeable batteries, however other suitable batteries may also be supported as is known in the art. Further, indicator lights can be disposed on the housing. The indicator lights can alert a user that the device is turned on and fully powered, as well as that the internal battery is low and needs recharged/replaced.

In one embodiment, the animal training collar device also comprises a USB/mini-USB charging port which is used for recharging the internal battery that provides power to various components of the animal training collar device.

In one embodiment, the animal training collar device is stored in a soft carrying case with an embossed logo or other indicia for easy transport. Typically, the carrying case comprises a handle and latch for securing the device within.

In one embodiment, the animal training collar device is integrally formed into a collar or can be utilized as an aftermarket device and secured to a standard/off-the-shelf pet collar.

In one embodiment, the animal training collar device will be water/dust resistant or waterproof as found suitable in the art in conditions normally experienced by pets in order to assure that the electronic capabilities will not lose functionality through normal daily use.

In one embodiment, the animal training collar device is available in a wide variety of colors, designs, patterns, and sizes.

In yet another embodiment, the animal training collar device comprises a plurality of indicia.

In yet another embodiment, a method of training an animal using vocal commands produced by the collar is disclosed. The method includes the steps of providing an animal training collar device comprising a body component configured a round-shaped animal collar with a built-in receiver/speaker. The method also comprises securing the body component around the neck of an animal to be trained. Further, the method comprises delivering voice, beep, vibration, and shock controls via the remote control, as needed. The method also comprises tracking the device via a mobile app when in range. Finally, the method comprises removing the body component and storing the device within the carrying case, when not in use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the animal training collar device of the present invention in accordance with the disclosed architecture;

FIG. 2 illustrates a perspective view of one embodiment of the animal training collar device of the present invention showing the remote in accordance with the disclosed architecture;

FIG. 3 illustrates a perspective view of one embodiment of the animal training collar device of the present invention showing the remote controlling two collars in accordance with the disclosed architecture;

FIG. 4 illustrates a perspective view of one embodiment of the animal training collar device of the present invention showing the collar and electrodes in accordance with the disclosed architecture;

FIG. 5 illustrates a perspective view of one embodiment of the animal training collar device of the present invention showing the carrying case in accordance with the disclosed architecture;

FIG. 6 illustrates a perspective view of one embodiment of the animal training collar device of the present invention showing the device with GPS tracking via a mobile app in accordance with the disclosed architecture;

FIGS. 7A-D illustrate a perspective view of one embodiment of the animal training collar device of the present invention showing the different components of the device in accordance with the disclosed architecture;

FIGS. 8A-C illustrate a perspective view of one embodiment of the animal training collar device of the present invention showing the device in use in accordance with the disclosed architecture; and

FIG. 9 illustrates a flowchart showing the method of training an animal using vocal commands produced by the collar in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an animal training collar device that allows a user to train an animal via vocal commands produced by the collar. There is also a long felt need in the art for an animal training collar device that comprises a built-in receiver/speaker system for delivering vocal commands. Further, there is a long felt need in the art for an animal training collar device that allows for voice, beep, vibration, and shock control options. Moreover, there is a long felt need in the art for a device that includes volume control, a built-in speaker, waterproof materials, and a carrying case. Further, there is a long felt need in the art for an animal training collar device that has one mile range with GPS tracking via a mobile app. Finally, there is a long felt need in the art for an animal training collar device that has the ability to control up to two collars within one remote.

The present invention, in one exemplary embodiment, is a novel animal training collar device. The animal training collar device comprises a body component that is configured in a conventional round-shaped animal collar. The body component secures around a user's neck and comprises a built-in receiver/speaker system for delivering vocal commands. The device allows for voice, beep, vibration, and shock control options. The device includes features, such as volume control, a built-in speaker, waterproof materials, a carrying case, adjustable vibration, and shock levels. Further, the device includes a one-mile range with GPS tracking via a mobile app. Additionally, the device has the ability to control up to two collars with one remote and includes rechargeable batteries. The present invention also includes a novel method of training an animal using vocal commands produced by the collar. The method includes the steps of providing an animal training collar device comprising a body component configured a round-shaped animal collar with a built-in receiver/speaker. The method also comprises securing the body component around the neck of an animal to be trained. Further, the method comprises delivering voice, beep, vibration, and shock controls via the remote control, as needed. The method also comprises tracking the device via a mobile app when in range. Finally, the method comprises removing the body component and storing the device within the carrying case, when not in use.

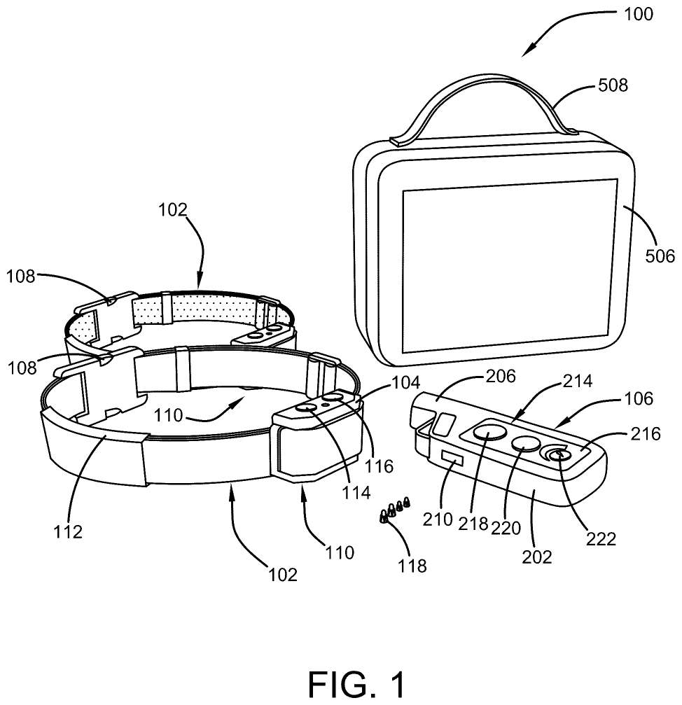

Referring initially to the drawings, FIG. 1 illustrates a perspective view of one embodiment of the animal training collar device 100 of the present invention. In the present embodiment, the animal training collar device 100 is an improved animal training collar device 100 that allows a user to train an animal via vocal commands produce by the device 100. Specifically, the animal training collar device 100 comprises a body component 102 with a built-in receiver/speaker 104 for delivering vocal commands. The body component 102 is secured around an animal's neck and is controlled by a remote control/control module 106.

Generally, the animal training collar device 100 of the present invention comprises all the features found in traditional training collars, plus the additional advantage of having a built-in receiver/speaker 104 designed for giving vocal commands to hunting dogs, herding dogs, and field trial dogs that have ranged outside of normal voice and whistle range, etc., or any other suitable animal that primarily utilizes vocal commands for training.

Other electronic training collars use beeps, vibrations, and electric shock to correct dogs, but hearing the trainer's voice can often be enough to correct behavior. Additionally, dog handlers know that field conditions and other distractions, such as distance, wind, heavy cover, other dogs, and other handlers' whistles or voice commands can often hinder a trainer's ability to communicate with their dog. Accordingly, the animal training collar device 100 of the present invention lets owners give direct vocal commands to their dogs, helping to focus their attention, and allowing them to hear their owner's voice loud and clear regardless of distance or environmental conditions.

Further, the animal training collar device 100 comprises a body component 102 that is configured in a round-shape for wrapping around the neck of a dog or other suitable animal. The body component 102 comprises a nylon or polyester material and has an appearance similar to a conventional dog collar for comfortable wearing of the body component 102. The elongated shape of the body component 102 is adapted to encircle the neck of a dog in a similar fashion as conventional dog collars known in the art. The body component 102 can be made of a slash-proof and soft material such as nylon webbing, polyester, hemp, or metal, etc., or any other suitable material as is known in the art.

In use, the body component 102 is secured around the neck of a dog via a buckle and a clip 108, which mate together and are integrated into the body component 102. Further, the buckle may comprise a key-locking mechanism that locks the clip 108 into the buckle when engaged. Additionally, any other type of fastening mechanism such as hook and loop, Velcro®, buckle, snap, etc., or any other mechanical fastener as is known in the art can be used for securing the ends of the body component 102.

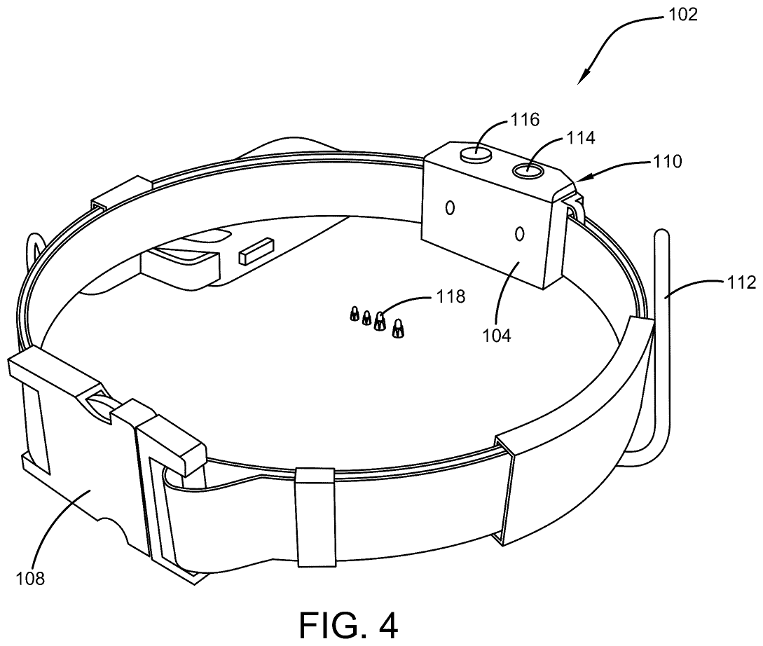

As shown in FIGS. 1 and 4, the body component 102 includes a waterproof housing 110 attached to the body component 102 or directly integrated within the body component 102, which includes a built-in receiver/speaker 104, a long-range antenna 112, and other circuitry necessary for delivering vocal commands, as well as for beep, vibration, and shock control options. Further, the built-in receiver/speaker 104 includes a low-profile volume control 114 with physical clicks to prevent accidental changes and a low-profile power button 116 to activate or deactivate the built-in receiver/speaker 104. Specifically, the power button 116 can be used for activation when the dog is wearing the body component 102 and being trained. For power saving properties, the power button 116 can be deactivated manually or after a predetermined amount of time when the body component 102 is not worn by the dog, the built-in receiver/speaker 104 will automatically shut off. Further, the built-in receiver/speaker 104 comprises interchangeable electrodes 118, which can be interchanged as necessary, allowing the device 100 to be utilized with long-haired and short-haired dogs and other animals.

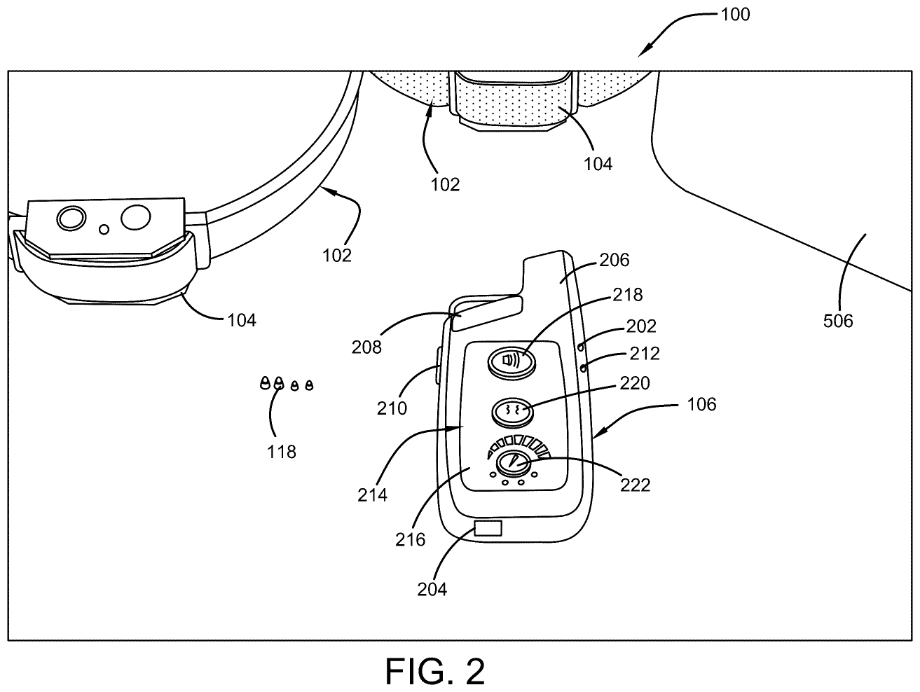

As shown in FIG. 2, the device 100 includes a remote control/control module 106 with an attached lanyard 200 for easy transport and a waterproof housing 202 for protection against the elements. The remote control/control module 106 includes a transmitter 204, an antenna 206, and other circuitry needed for sending vocal commands to the body component/collar 102. Further, the remote control/control module 106 includes a microphone 208 and a push-to-talk button 210, which allows a user to speak their commands into the remote control 106. The control module 106 also comprises a recessed channel switch 212, which allows a user to switch between channels, as needed to avoid any interference while using the device 100. Additionally, the control module 106 includes low-profile buttons 214 within a recessed face 216. The low-profile buttons 214 include a first button 218 for sounding a beep, a second button 220 for sending a vibration, and a third button 222 that sends a shock. The third button 222 is a smaller button with a dial to control the concentration of the shock being sent. If a user wants to send a continuous shock, the third button 222 can be held down. The low-profile buttons 214 allow for adjustable vibration and shock stimulation levels, as needed.

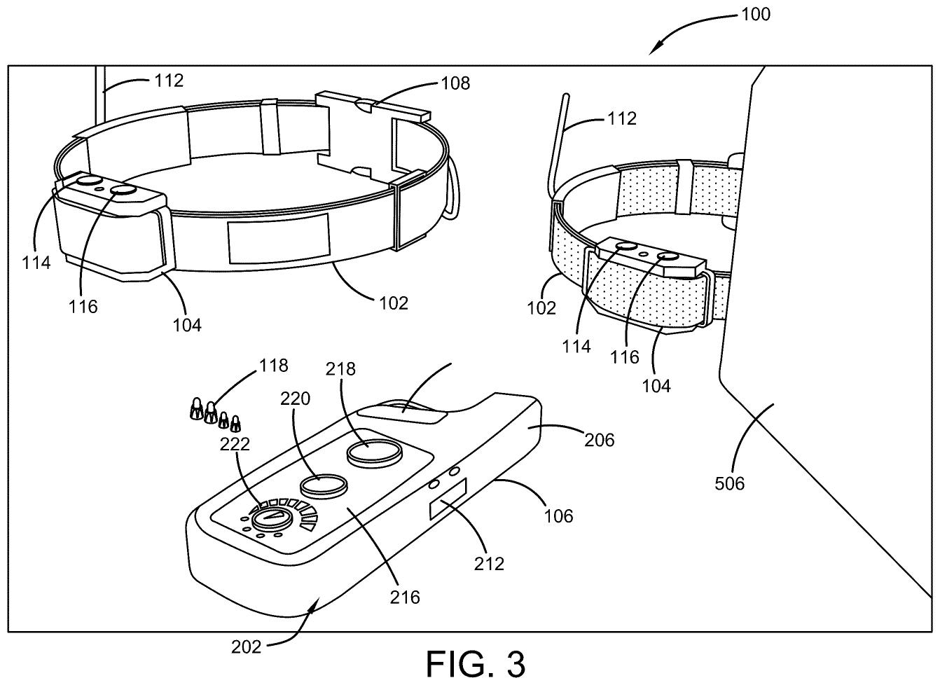

As shown in FIG. 3, the animal training collar device 100 has the ability to control up to two body components/collars 102 with one remote control/control module 106.

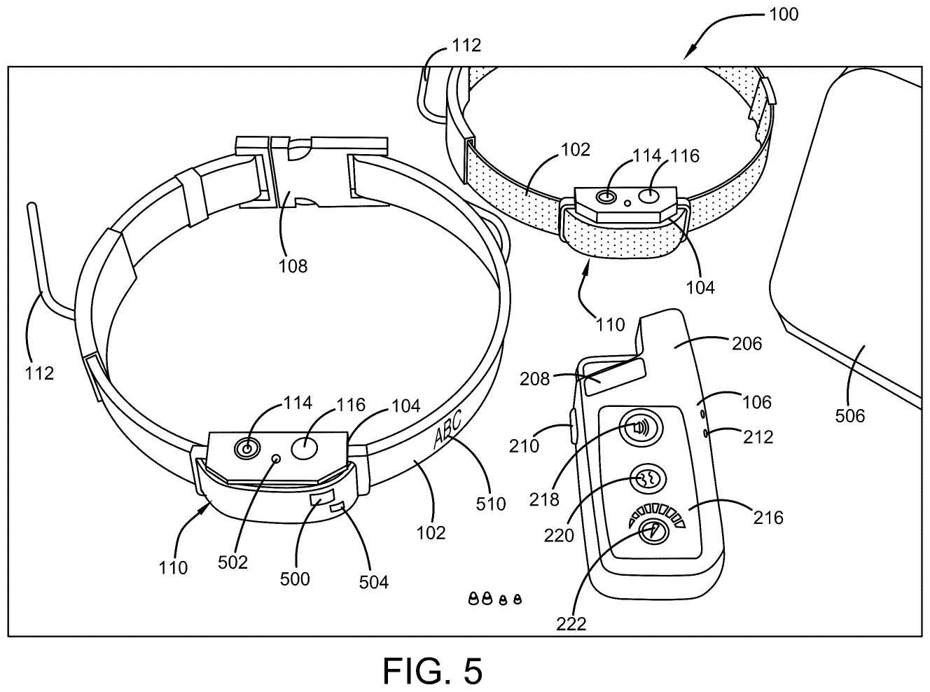

As shown in FIG. 5, the animal training collar device 100 of the present invention comprises an internal battery 500, which runs for up to forty hours or more. Typically, the animal training collar device 100 may support built-in high-capacity lithium rechargeable batteries 500, however other suitable batteries may also be supported as is known in the art. Further, indicator lights 502 can be disposed on the housing 110. The indicator lights 502 can alert a user that the device 100 is turned on and fully powered, as well as that the internal battery 500 is low and needs recharged/replaced. Further, the animal training collar device 100 also comprises a USB/mini-USB charging port 504 which is used for recharging the internal battery 500 that provides power to various components of the animal training collar device 100.

Further, the battery 500 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the animal training collar device 100. Throughout this specification, the term “battery” may be used interchangeably to refer to one or more wet or dry cells or batteries of cells in which chemical energy is converted into electricity and used as a source of DC power. References to recharging or replacing the battery 500 may refer to recharging or replacing individual cells, individual batteries of cells, or a package of multiple battery cells as is appropriate for any given battery technology that may be used. In addition, a rechargeable embodiment of the battery 500 may be recharged using a USB port 504, wherein the USB port 504 is a USB-A, USB-B, Micro-B, Micro-USB, Mini-USB, or USB-C port, etc.

In one embodiment, the animal training collar device 100 is stored in a soft carrying case 506 with an embossed logo or other indicia for easy transport. Typically, the carrying case 506 comprises a handle 508 and latch for securing the device 100 within.

In yet another embodiment, the animal training collar device 100 comprises a plurality of indicia 510. The body component 102 of the device 100 may include advertising, a trademark, or other letters, designs, or characters, printed, painted, stamped, or integrated into the body component 102, or any other indicia 510 as is known in the art. Specifically, any suitable indicia 510 as is known in the art can be included, such as but not limited to, patterns, logos, emblems, images, symbols, designs, letters, words, characters, animals, advertisements, brands, etc., that may or may not be animal training, voice commands, or brand related.

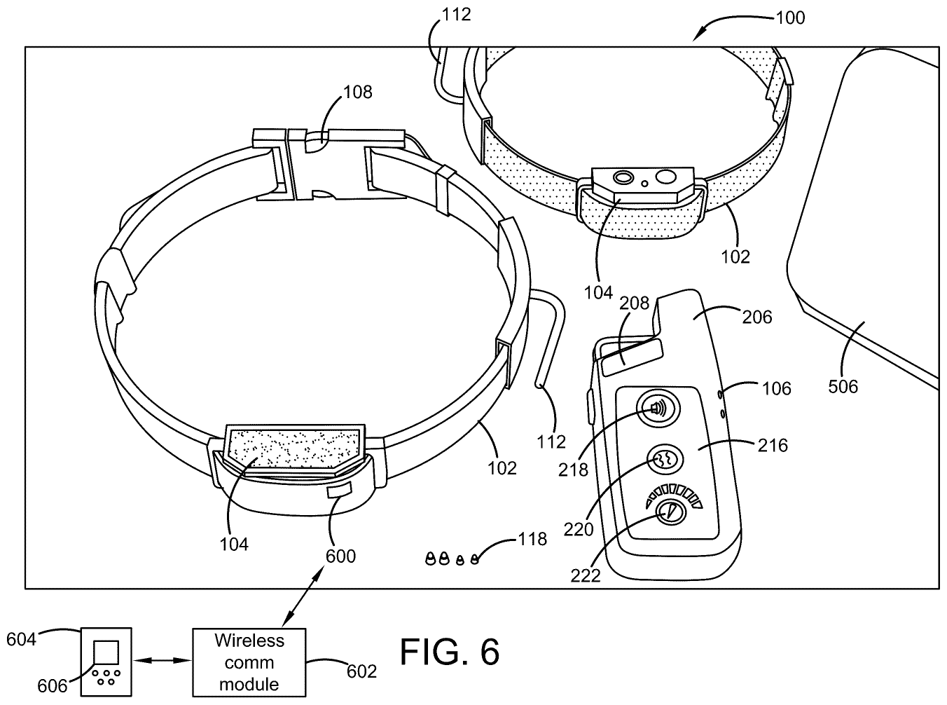

As shown in FIG. 6, the housing 110 comprises a GPS tracker 600 which allows users to track the location of their pet. Typically, the device 100 has a one-mile range for transmitting and receiving voice commands. Specifically, the housing 110 has a built-in GPS chip 600 that determines the location of the body component 102 and provides the location information to the dog owner using a wireless communication module 602 connected to a paired smart device 604. Specifically, the wireless communication module 602 establishes a wireless communication channel with the paired smart device 604. Further, the animal training collar device 100 connects to the smart device 604, such as smartphone, personal digital assistant, or any other such type of electronic/mobile device using the wireless communication medium/module 602 such as Bluetooth, Wi-Fi or any other similar short range or long-range wireless technology as is known in the art. Specifically, the smartphone device 604 comprises an installed mobile application 606 that receives information related to the location of the animal, etc., in real time. The alert or notification shown on the mobile application 606 may be in the form of a push notification, audio alert or a visual alert, etc., or any other suitable notification as is known in the art.

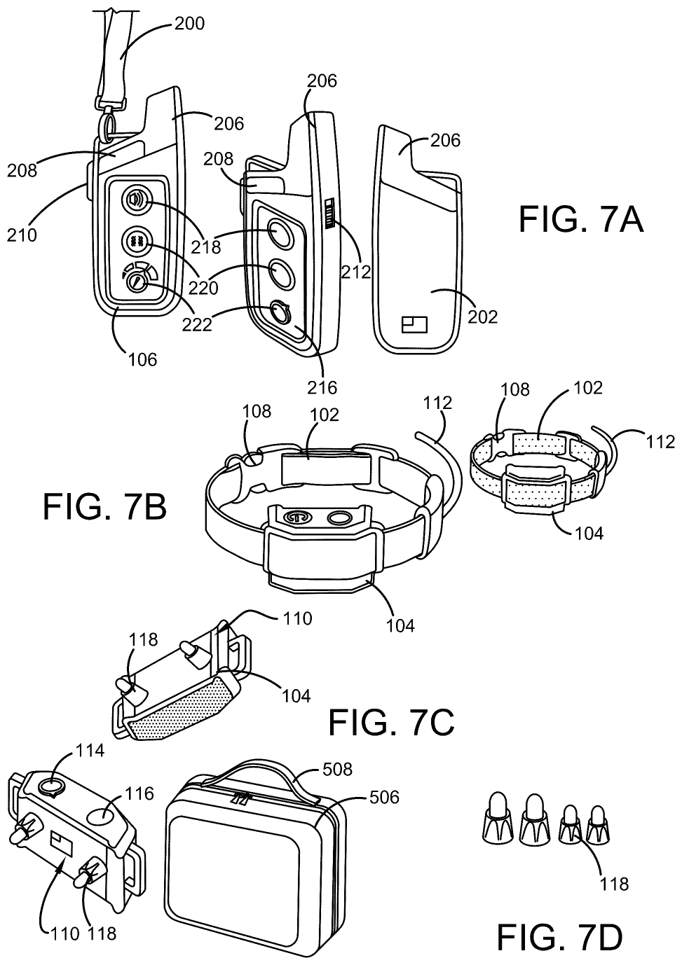

As shown in FIGS. 7A-D and 8A-C, the animal training collar device 100 is integrally formed into a collar or can be utilized as an aftermarket device and secured to a standard/off-the-shelf pet collar. Typically, the animal training collar device 100 will be water/dust resistant or waterproof as found suitable in the art in conditions normally experienced by pets in order to assure that the electronic capabilities will not lose functionality through normal daily use. Additionally, the animal training collar device 100 is available in a wide variety of colors, designs, patterns, and sizes.

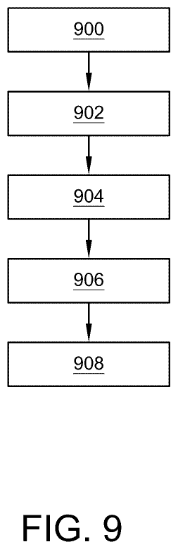

FIG. 9 illustrates a flowchart of the method of training an animal using vocal commands produced by the collar. The method includes the steps of at 900, providing an animal training collar device comprising a body component configured as a round-shaped animal collar with a built-in receiver/speaker. The method also comprises at 902, securing the body component around the neck of an animal to be trained. Further, the method comprises at 904, delivering voice, beep, vibration, and shock controls via the remote control, as needed. The method also comprises at 906, tracking the device via a mobile app when in range. Finally, the method comprises at 908, removing the body component and storing the device within the carrying case, when not in use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “animal training collar device”, “animal training device”, “collar device”, and “device” are interchangeable and refer to the animal training collar device 100 of the present invention.

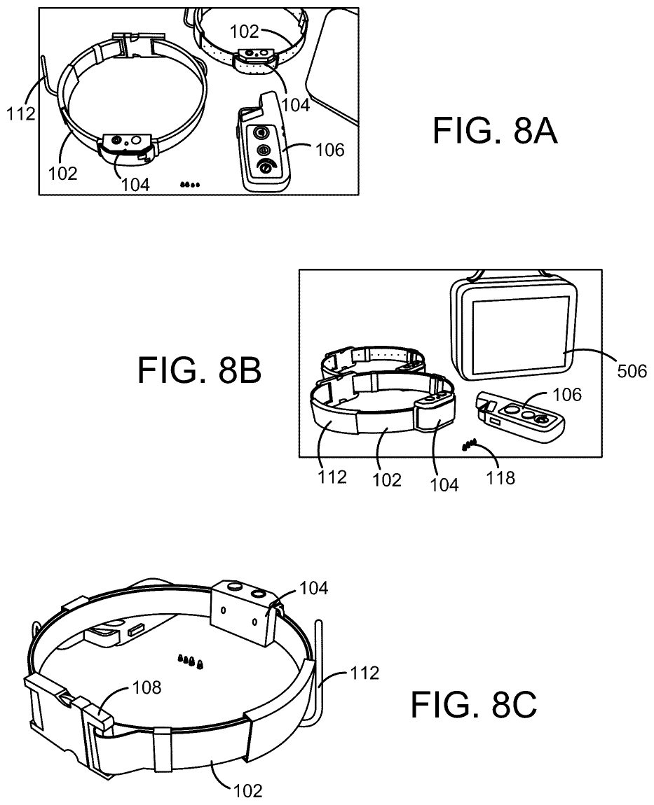

Notwithstanding the forgoing, the animal training collar device 100 of the present invention can be of any suitable size and configuration as is known in the art without affecting the overall concept of the invention, provided that it accomplishes the above stated objectives. One of ordinary skill in the art will appreciate that the animal training collar device 100 as shown in FIGS. 1-9 is for illustrative purposes only, and that many other sizes and shapes of the animal training collar device 100 are well within the scope of the present disclosure. Although the dimensions of the animal training collar device 100 are important design parameters for user convenience, the animal training collar device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal training collar device that allows a user to train an animal via vocal commands, the animal training device comprising:
a body component; and
a control module;
wherein the body component is secured around an animal's neck;
wherein the body component comprises a built-in receiver/speaker for delivering vocal commands; and
further wherein the body component is controlled by the control module.

2. The animal training collar device of claim 1, wherein the body component is adapted to encircle a neck of a dog in a similar fashion as conventional dog collars known in the art.

3. The animal training collar device of claim 2, wherein the body component is manufactured of a slash-proof and soft material such as nylon webbing, polyester, hemp, or metal.

4. The animal training collar device of claim 3, wherein the body component is secured around the neck of a dog via a buckle and a clip, which mate together and are integrated into the body component.

5. The animal training collar device of claim 4, wherein the body component includes a waterproof housing attached to the body component or directly integrated within the body component, which includes the built-in receiver/speaker, a long-range antenna, and other circuitry necessary for delivering vocal commands, as well as for beep, vibration, and shock control options.

6. The animal training collar device of claim 5, wherein the built-in receiver/speaker includes a low-profile volume control with physical clicks to prevent accidental changes and a low-profile power button to activate or deactivate the built-in receiver/speaker.

7. The animal training collar device of claim 6, wherein the built-in receiver/speaker comprises interchangeable electrodes, which can be interchanged as necessary, allowing the animal training collar device to be utilized with long-haired and short-haired dogs and other animals.

8. The animal training collar device of claim 7, wherein the control module comprises an attached lanyard for easy transport and a waterproof housing for protection against elements.

9. The animal training collar device of claim 8, wherein the control module includes a transmitter, an antenna, and other circuitry needed for sending vocal commands to the body component.

10. The animal training collar device of claim 9, wherein the control module includes a microphone and a push-to-talk button, which allows a user to speak their commands into the control module.

11. The animal training collar device of claim 10, wherein the control module comprises a recessed channel switch, which allows a user to switch between channels, as needed to avoid any interference while using the animal training collar device.

12. The animal training collar device of claim 11, wherein the control module includes low-profile buttons within a recessed face, that include a first button for sounding a beep, a second button for sending a vibration, and a third button that sends a shock.

13. The animal training collar device of claim 12, wherein the control module has ability to control up to two body components.

14. The animal training collar device of claim 13, wherein the housing of the built-in receiver/speaker comprises a GPS tracker which pairs with a smart device to allow users to track location of their pet.

15. An animal training collar device that allows a user to train an animal via vocal commands, the animal training collar device comprising:
a body component adapted to encircle a neck of a dog in a similar fashion as conventional dog collars; and
a control module comprising an attached lanyard for easy transport and a waterproof housing for protection against elements;
wherein the body component includes a waterproof housing attached to the body component or directly integrated within the body component, which includes a built-in receiver/speaker, a long-range antenna, and other circuitry necessary for delivering vocal commands, as well as for beep, vibration, and shock control options;
wherein the built-in receiver/speaker includes a low-profile volume control with physical clicks to prevent accidental changes and a low-profile power button to activate or deactivate the built-in receiver/speaker, as well as interchangeable electrodes;
wherein the body component is controlled by the control module, which includes a transmitter, an antenna, and other circuitry needed for sending vocal commands to the body component;
wherein the control module includes a microphone and a push-to-talk button, which allows a user to speak their commands into the control module;
wherein the control module includes low-profile buttons within a recessed face, that include a first button for sounding a beep, a second button for sending a vibration, and a third button that sends a shock;
wherein the control module has ability to control up to two body components; and
further wherein the housing of the built-in receiver/speaker comprises a GPS tracker which pairs with a smart device to allow users to track location of their pet.

16. The animal training collar device of claim 15 further comprising a rechargeable battery.

17. The animal training collar device of claim 16, wherein the housing of the built-in receiver/speaker comprises indicator lights to alert a user when the rechargeable battery is fully charged and a USB charging port for recharging the rechargeable battery.

18. The animal training collar device of claim 15, wherein the animal training collar device is stored in a soft carrying case with a handle.

19. The animal training collar device of claim 15, wherein the GPS chip determines location of the body component and provides location information to the user using a wireless communication module connected to the paired smart device, which alerts the user via an installed mobile application on the paired smart device, that receives information related to location of the pet in real time.

20. A method of training an animal using vocal commands produced by the collar, the method comprising the following steps:
providing an animal training collar device comprising a body component configured as a round-shaped animal collar with a built-in receiver/speaker;
securing the body component around the neck of an animal to be trained;
delivering voice, beep, vibration, and shock controls via the remote control, as needed;
tracking the device via a mobile app when in range; and
removing the body component and storing the device within the carrying case, when not in use.
